(19) United States
(12) Patent Application Publication
(10) Pub. No.: US 2006/0112430 A1
(43) Pub. Date: May 25, 2006

(54) Method and apparatus for immunizing data in computer systems from corruption

(76) Inventors: Jerrold M. Deisenroth, Concord, MA (US); J. Michael Greata, Ipswich, MA (US)

Correspondence Address: GEORGE A. HERBSTER, 40 BEACH STREET, SUITE 303, MANCHESTER, MA, 01944, US

(21) Appl. No.: 10/993,920

(22) Filed: Nov. 19, 2004

(51) Int. Cl. G06F 12/14

(52) U.S. Cl. 726/22

(57) ABSTRACT

A system for immunizing a computer network against adverse effects caused by the receipt of a corrupting message, such as a message with a file infected with a virus. An incoming message deemed to be a valid message is delivered to a recipient computer system in the network. If the incoming message is not deemed a valid message, it transfers to a blocked message store. A blocked message handler controlled by forwarding rules may delete the message, designate the message for deletion, transfer the message to the recipient computer system or allow the recipient access to the message on a restricted basis. Such access may be limited to copying the message to a sacrificial machine and viewing the message remotely. Alternatively, access could allow message manipulation in the sacrificial machine and generation of a derivative of the message for transfer to the recipient computer system.

### BACKGROUND OF THE INVENTION

1. Field of the Invention

This invention generally relates to security of data processing systems. More specifically this invention relates to a method and apparatus for immunizing one or more computer systems in a network against attacks, as by computer viruses and the like, while preserving useful access to data.

2. Description of Related Art

Computer systems interconnect through various internal networks and external networks such as the Internet. At a given location, individual computers may connect to the Internet directly. In other locations, one or more individual computers, or users, may interconnect by means of an internal network to a server that connects to the Internet. Both types of systems are susceptible to damage by so-called “viruses”. Generally a virus is received as a program or piece of code that typically is part of a message. E-mails, instant messages or other file transfer protocols are different types of messages. A virus-infected message generally corrupts data by replicating itself in a receiving party's, or “recipient's” computer system or by transmitting itself across a network even bypassing firewalls and other security systems. In the following discussion the phrase “corrupting message” refers to any message, such as an e-mail with an infected attachment, that can corrupt the contents of one or more files or otherwise disrupt operations in a computer system.

Companies like Symantec Corporation and MacAfee, Inc. have developed virus detection programs. A virus detection program typically resides on the same hard disk as receives the messages. Such a program compares an incoming message with a set of conditions, often called “definitions” or “signatures,” that define known viruses. If an incoming message meets one of these conditions, it is presumed to be a corrupting message and is isolated by being deleted or by being placed in quarantine.

As described above, the incoming message is processed in the same memory as other programs. As alternative, it is possible to use a sacrificial machine as a destination for each incoming message. For example, United States Patent Application Publication No. US2002/0166067 discloses a host personal computer and a separate sacrificial VTS (Virus Trap computer System) machine. The VTS machine is a separate computer system that receives all communications that are directed to a host personal computer. The VTS machine detects intrusions and includes a virus detector. If a virus is detected, the entire VTS machine is sacrificed and then restored from a secure memory.

Drawbacks characterize each of these systems. First, both the foregoing and other approaches to the detection of viruses and prevention of corruption require an a priori knowledge of a virus. Thus the system that receives a “yet to be defined” virus or “new” virus may process a corrupting message with adverse results notwithstanding having tested the message for a virus. This potential for processing of corrupting messages by a given system continues for an indefinite number of days until the virus has been identified and a definition has been transferred to the virus detection system in that given system. A corrupting message that fails to be detected is called a “false negative” message.

Second, virus detection systems are subject to identifying non-corrupted messages as being infected. Any such message is called a “false positive” message. A “false positive” message exists when a virus detection system detects a non-corrupting message as a corrupting message because the non-corrupting accidently meets a virus detection condition. In many situations the “false positive” message is lost to the recipient even though the message in fact contains no virus. A “false negative” message exists when a virus detection system fails to detect a corrupting message because the message does not meet any of the virus detection conditions.

What is needed is a method and apparatus that is easy to implement that: (1) allows known valid messages to pass to the recipient's computer system, (2) immunizes computer systems in a network from the adverse impacts of false positive and false negative messages, and (3) permits the recipient controlled, safe access to those messages that are not deemed to be valid, including false positive messages, for the purpose of viewing and/or manipulating such messages.

### SUMMARY

Therefore it is an object of this invention to immunize computer systems in a network from the adverse effects of corrupting messages.

Another object of this invention is to immunize a computer systems in a network from the adverse effects of corrupting messages while allowing a recipient computer system in the network restricted access to some or all messages that appear to be corrupting.

Still another object of this invention is to provide a method and apparatus for immunizing a computer system against the adverse effects that otherwise would occur if a corrupting message were received in a recipient's computer system even before the characteristics of the corrupting message have been defined.

This invention can be applied to a variety of data processing systems, typically to a data processing network including a server machine, or “server”, and at least recipient computer system that is to receive the message. The server interfaces the recipient computer system to a communications path over which messages, including potentially corrupting messages, are received.

In accordance with one aspect of this invention, immunization is achieved by providing a blocked message store and by testing the message against predetermined criteria. If the message meets criteria for a valid message, the message transfers to the recipient. Otherwise, the message transfers to the blocked message store.

In accordance with another aspect of this invention, a network including a set of criteria by which each message can be classified as a blocked message and a set of forwarding rules that control the processing of a blocked message. Each incoming message classified as a blocked message transfers to the blocked message store for processing in accordance with a forwarding rule that applies to that blocked message.

In accordance with yet another aspect of this invention, the network includes a server with a blocked memory store. Each received message is processed to determine message status, with a first or second status value with the first status value being assigned if the message is deemed to be free of any potentially corrupting criteria. If the first value is assigned, the message is transferred to the recipient computer system. If the second value is assigned, the message transfers to the blocked message store. A handling module selects a message in the blocked message store and obtains characteristics of the message. Then the message is processed according to one of a set of forwarding rules that control message processing.

### BRIEF DESCRIPTION OF THE DRAWINGS

The various objects, advantages and novel features of this invention will be more fully apparent from a reading of the following detailed description in conjunction with the accompanying drawings in which like reference numerals refer to like parts, and in which:

FIG. 1 is a block diagram of a data processing network incorporating this invention;

FIG. 2 is a flow chart of a server testing module used in the server of FIG. 1;

FIG. 3 is a flow chart of a blocked message handler module used in the server of FIG. 1;

FIG. 4 is a flow diagram of a sacrificial machine testing module used in a sacrificial machine shown in FIG. 1; and

FIG. 5 is a flow chart of an administrative (ADMIN) module that may reside in the server shown in FIG. 1.

### DESCRIPTION OF ILLUSTRATIVE EMBODIMENTS

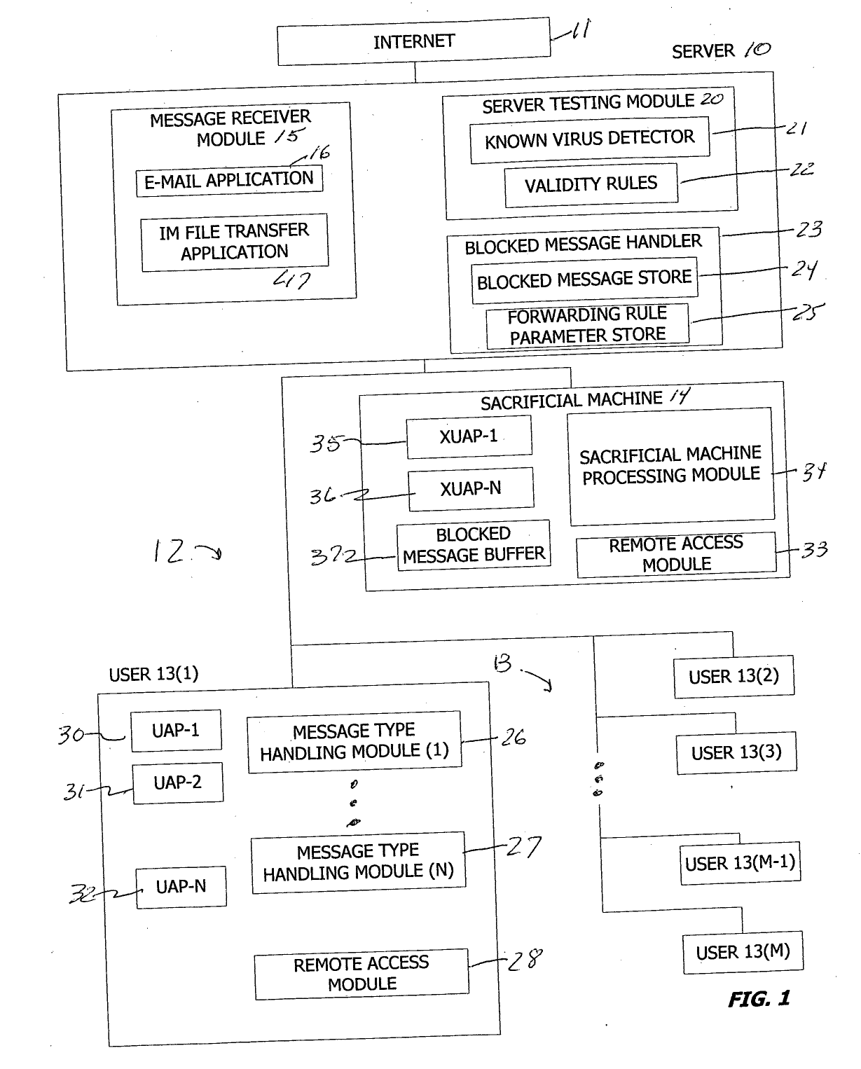

FIG. 1 depicts a typical data processing network that includes a server 10 interfaced to the Internet 11 as an example of an external communications path over which messages can be received. The server 10 also connects through an internal network 12 to a plurality of users 13. Specific users 13(1) through 13(M) are shown. For purposes of this discussion only user 13(1) is shown in detail.

As known, an e-mail or other message is directed to a specific user as a “recipient” to be processed on the recipient's computer system, or “recipient computer system”. That term and phrase will be used in the remainder of this disclosure and is intended to include any device capable of establishing two-way communications with a network. Such devices include, but are not limited to workstations, personal computers, certain cell phones and personal digital assistants (PDA's). While this term can be applied to any user in a network, for purposes of clarity this discussion assumes that user 13(1) is the recipient. The use of this invention to protect each user in a network, when that user is a recipient, will become apparent to those of ordinary skill in the art.

In accordance with this invention the network includes a sacrificial machine 14 with computing capabilities. In FIG. 1 the sacrificial machine 14 is depicted as a physical computer system that includes a processor, random access memory and sequential memory, as for example, a magnetic data storage device. The sacrificial machine 14 may also be implemented in any number of alternate forms, such as a single virtual machine or a separate virtual machine for each user or class of users in the network. In whatever form, the sacrificial machine 14 will have capabilities for processing application programs as are available to a user, as more described more fully hereinafter.

The server 10, as is typical, includes a message receiver module 15 that receives all incoming messages from the Internet. The specifically disclosed message receiver 15 has two message handling applications as examples, namely: an e-mail application 16 and an Instant Messaging (IM) file transfer application 17. Such applications are well known in the art. As will be apparent, a specific server may include one or more of the foregoing or other message handling applications. For the purpose of understanding this invention, these applications normally (1) receive messages of a corresponding type, (2) process those messages and (3) send the message and any attached files to specified locations in a recipient computer system.

In accordance with this invention, the server 10 includes a server testing module 20 that includes a known virus detector 21 and a table of validity rules 22, provided, for example, as database objects. The known virus detector 21 incorporates virus definitions that constitute a set of predefined corrupting message criteria. The validity rules 22 constitute a set of predefined criteria that identify a message as a “valid” message.

In a preferred method of operation, the server testing module 14 compares an incoming message against one or two sets of criteria. If the message does not match any of the corrupting message criteria established by the known virus detector 21 and matches the valid message criteria of the validity rules 22, the message can considered as having a first status value and is sent to the recipient as is normal. Otherwise the message is designated as a “blocked” message, as an example of a second status value, and is sent to a blocked message handler 23, particularly a block message store 24. The blocked message handler 23 subsequently processes the blocked message in accordance with a set of forwarding rules defined by information in a forwarding rules parameter store 25.

Each user has a plurality of message type handling modules; with two such modules 26 and 27 shown in FIG. 1 by way of example. Typically there will be one such module for each different type of message application available to the user, such as one or more of the e-mail and IM file transfer applications 16 and 17.

Each user will include a remote access module 28 and a number of user application programs. FIG. 1 discloses three such user application programs designated as UAP-1 through UAP-N application programs 30, 31 and 32. These are typically commercially available programs, such as Microsoft Word, Microsoft Excel, Microsoft Access, WordPerfect, and other application programs.

The sacrificial machine 14 includes a remote access module 33 that is adapted to interact with the remote access module 28 and similar modules at other users. When remote access is enabled, the user computer system functions as a remote terminal. All message processing occurs in the sacrificial machine 14 under the control of a sacrificial machine processing module 34. For example, the sacrificial machine 14 is shown with XUAP-1 and XUAP-N applications 35 and 36 that correspond to the UAP-1 and UAP-N applications 30 and 32, respectively. Each application in the sacrificial machine 14 may be an exact copy of the application at the user. Preferably, however, an XUAP-N application will be an abridged version of the UAP-N application program that includes only those features necessary for limited processing of blocked message. Alternatively the XUAP-N application may comprise a functional equivalent of the important criteria of the UAP-N application program.

The sacrificial machine 14 will also include memory assigned as a blocked message buffer 37. With this organization, the sacrificial machine has the capability of receiving and processing a message including any attachments. However, the sacrificial machine 14 is isolated from the server 10 and each user 13, including the recipient 13(1), although the recipient has access to the message through the remote access modules 28 and 33 on a restricted basis.

### Server Testing Module 20

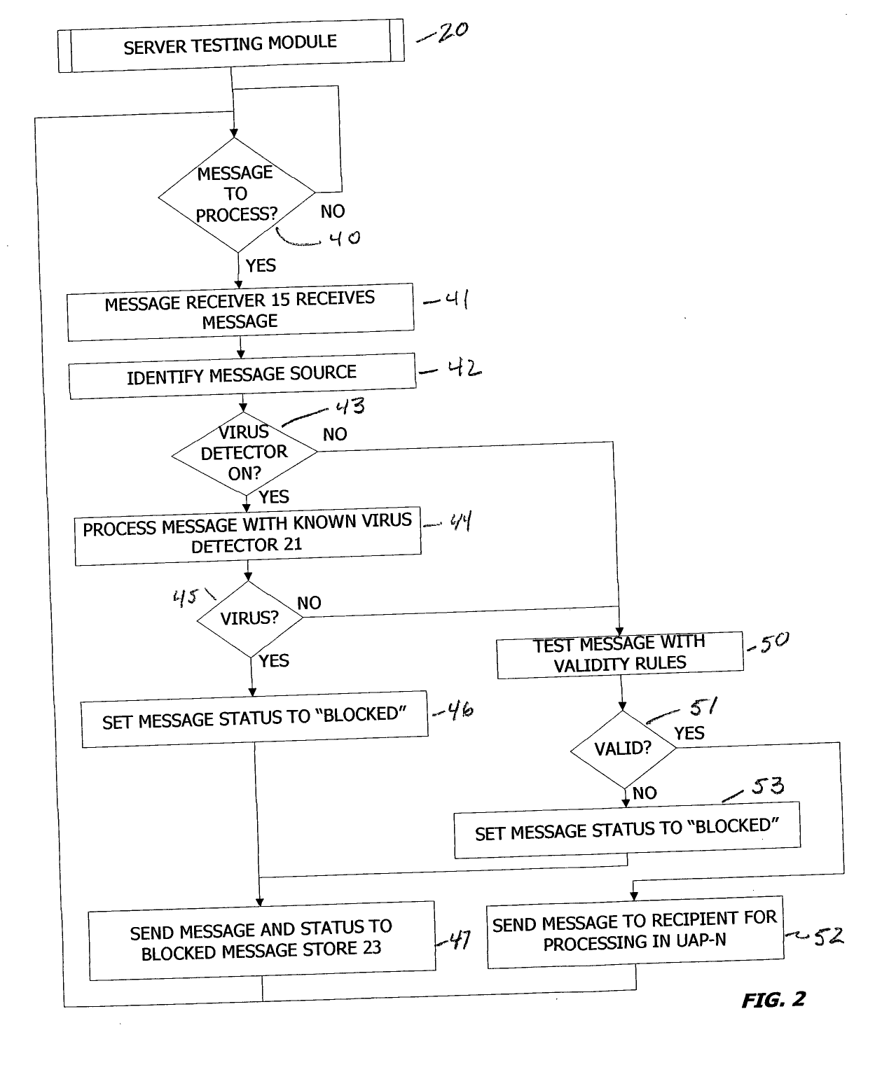

FIG. 2 depicts one embodiment of the server testing module 20 that interacts with each incoming message and utilizes the known virus detector 21 and the validity rules 22 as shown in FIG. 1. Steps 40 and 41 of FIG. 2 represent the receipt of a message in the message receiver 15. Step 42 identifies the message source to determine which type of application will process the message, such as an e-mail message to be processed by the e-mail application 16 in FIG. 1.

At this point control can pass to an optional switch for controlling virus detection. Specifically step 43 represents a switch that determines whether any virus detection will occur. The administrator will normally control this switch. Maximum throughput of this invention will be realized if the switch is “ON”.

If the switch is “ON”, step 43 transfers control to step 44 that processes the message with the known virus detector 21 in FIG. 1 to determine whether the message contains any characteristics that match the conditions that the known virus detector 21 defines. If the message matches any of these conditions, the message is deemed to be a “blocked” message that may be either an actually infected message or a false positive. Step 45 transfers to step 46 that sets a message status to a to indicate that the message either is infected or is a false positive. Step 47 transfers the message to the blocked message store 23. This transfer also includes the above message status and related other message characteristics, such as the message status and other sender's address, the user's address, date, time, etc. This transfer to the blocked message store 24 assures that any blocked message does not become accessible by the recipient without further processing. As will be apparent, should the blocked message actually be free of any virus, the blocked message is not deleted or quarantined. The blocked message is available for access under restrictions.

If no virus is detected, the message either is actually free of any virus or is a false negative. In this case, step 45 transfers control to step 50 that tests the message with respect to the validity rules 22. These rules can range from the simple to the complex. Each rule generally will be specific to a particular application. The criteria also will be specific to each user application in the network. For example, if the UAP-1 application 30 is a word processing application, attributes consistent with a valid message might include a lack of macros in the message. An application specific rule may then comprise a single attribute or a logical combination of attributes. Basically the rule is one of a series of criteria in the validity rules 21 of FIG. 1 that, if met, designates a message as a “valid” message. Collectively the validity rules 22 comprise a set of criteria that define messages that are known to be valid.

If step 51 then determines whether the message is valid, control transfers to step 52 that sends the message directly to the recipient for processing by the appropriate message type handling module in a normal manner. For example, the recipient is allowed to process an e-mail message and any attached files within the recipient's data processing system.

If the test at step 51 is not valid, step 53 sets the status to the second or “blocked” value. Step 47 then sends the message and status and related message characteristics to the blocked message store 24.

As will now be apparent, the server testing module 20 functions to process each incoming message and forward only “valid” messages to a recipient where a “valid” message is an incoming message that meets validity criteria and that does not contain a known virus assuming the virus detection is active. All other messages are blocked and sent to the blocked message store 24. Thus the blocked message store 24 is a repository for messages that may or may not include a virus and may or may not be valid. Collectively they represent a set of messages of questionable validity that require special handling.

### Blocked Message Handler Module 23

The blocked message handler module 23 in the server 10 provides this special handling. Specifically, the blocked message handler or module 23 monitors the blocked message store 24 and controls the disposition of each blocked message in accordance with forwarding rules defined by the forwarding rule parameters 25. Step 60 selects one such message for processing.

Step 61 extracts forwarding rule parameters from the forwarding rules parameters store 25 and the message characteristics from the blocked message store 24. The forwarding rules parameters may includes input parameters such as (1) a specific user identification or a user class specification, (2) a status parameter that modifies a response on the basis of the message status, such as whether the message was previously processed by the validity rules, (3) a source address list and (4) a user authority. Other input parameters may also be involved. Each rule defines a combination or a set of these parameter values and generates a rule output that controls the handling of or action taken with respect to the blocked message. The general implementation of forwarding rules and the forwarding rules store 25 will be known to a person of ordinary skill in the art.

Step 62 determines whether steps 44 and 45 in FIG. 2 determined that the message was deemed to have a virus. If it was, the message was not tested against the validity rules. In this case, step 62 transfers control to step 63 to determine if the message meets the criteria for a valid message. If the message meets those criteria, step 64 transfers control to step 65 that sends the message to the recipient computer system and deletes the message from the blocked message store 24.

If the message characteristics indicate that the message is free from any virus, control transfers from step 62 to step 66. If the message does not meet the criteria for as valid message, control transfers from step 64 to step 66.

Step 66 represents the processing of the blocked message in accordance with the forwarding rules. That is, the various message characteristics will match one set of forwarding rule parameters to generate a rule output that determines the ultimate handling of the message.

Step 67 is the first in a series of steps that represents one specific logical implementation of a process for generating a rule output based upon the various inputs. Step 67 represents a test to determine the rule output is to delete the blocked message. If it is, the rule output may also establish a notification protocol represented by step 67 that will transfer to step 68 to see if the rule output requires such a user notification. If it does, step 68 transfers to step 69 whereby the blocked message handler module 23 sends a notification to the recipient. Step 69A represents the procedure for deleting the message from the blocked message store 24. This process may involve actual deletion of the message, with or without the generation of audit information, or merely designate the message for deletion by a utility application.

Another possible rule output is to allow the user some limited access to the blocked message, but under controls that prevent any inadvertent transfer of the message. In that event, step 67 transfers control to step 70 that, in turn, transfers control to step 71. Step 71 creates a remote access session between the recipient and the sacrificial machine 14. Basically step 71 establishes a link between the remote access module 33 in the sacrificial machine 14 and a remote access module associated with the recipient, such as the remote access module 28 associated with user 13(1) in FIG. 1. In a typical remote access environment, the recipient's computer system acts as remote terminal. A recipient's input is not processed by any application at the recipient's computer system. The remote access module transfers the input to a host computer system for processing, in this case the sacrificial machine 14. All server output from the sacrificial machine 14 as a host computer is then replicated to the recipient's computer system screen as a remote terminal.

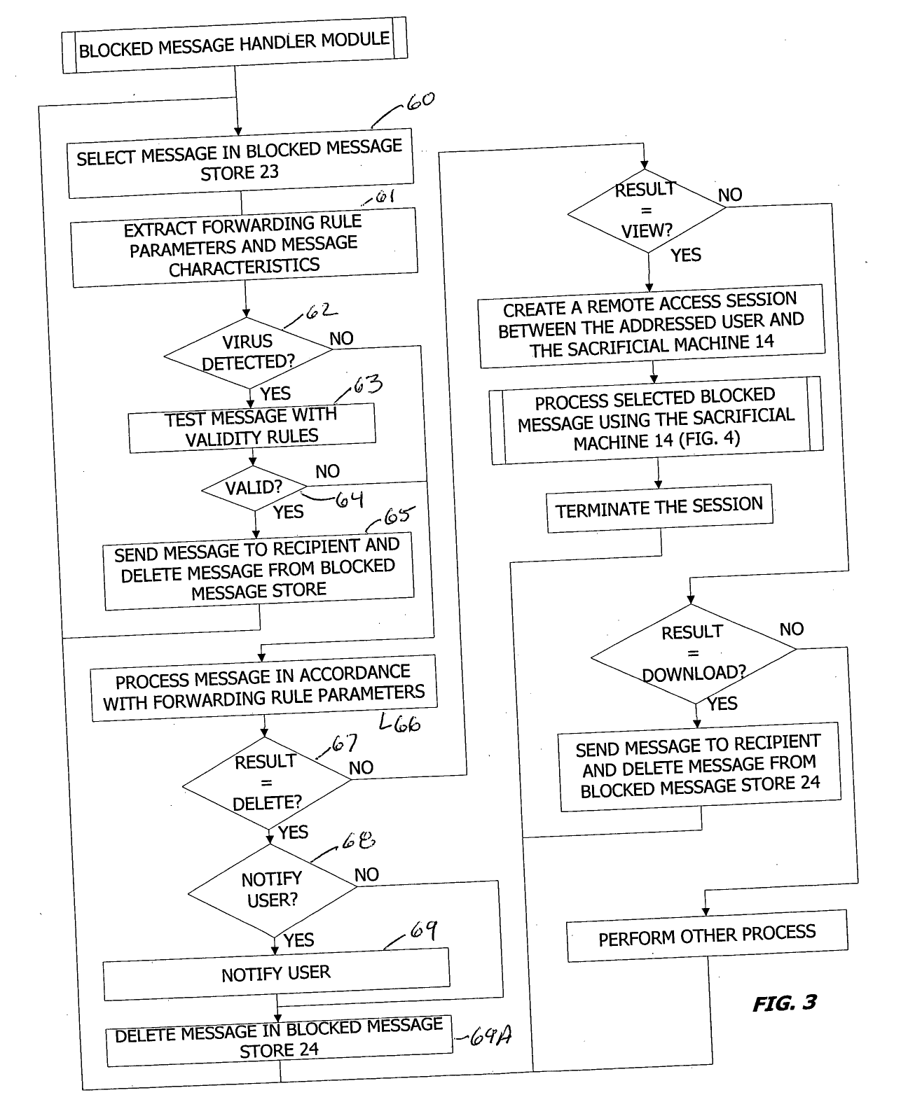

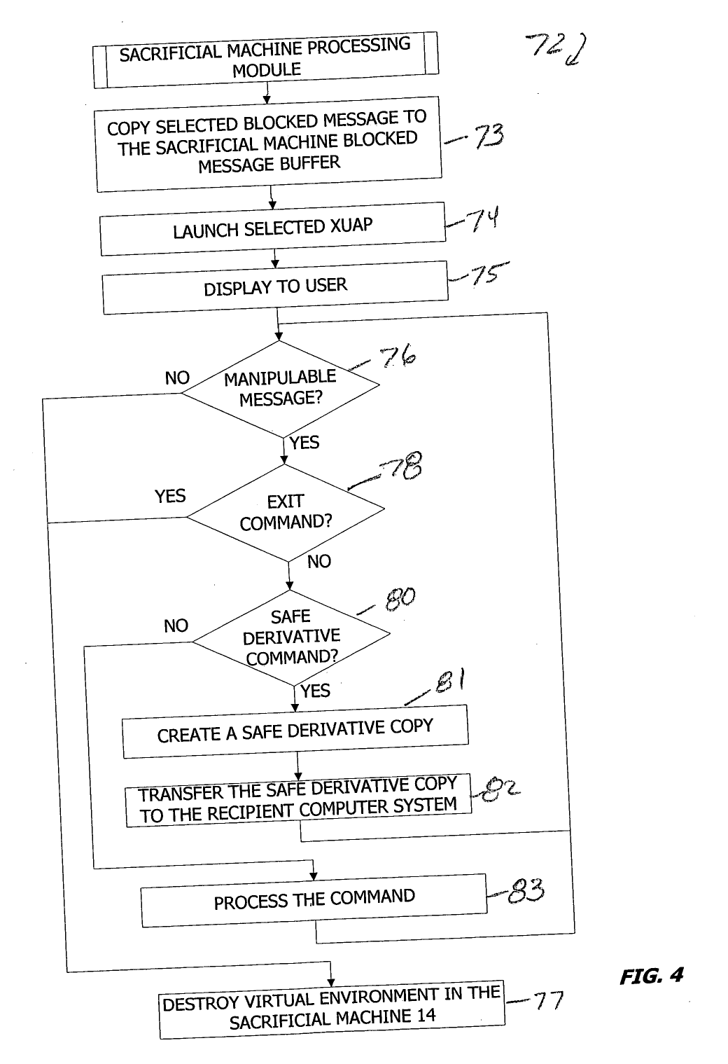

After step 71 in FIG. 3 creates the remote access session, procedure 72 processes the selected blocked message as shown in greater detail in FIG. 4. More specifically, step 73 copies the selected blocked message including any attachments to the blocked message buffer 37 in FIG. 1. Then step 74 launches a selected XUAP application in the sacrificial machine 14. For example, if the UAP-1 program 30 comprises a spreadsheet application, the XUAP-1 application may comprise a complete or abridged version of the spreadsheet application as previously described. In this example, step 74 might launch the e-mail application in the sacrificial machine 14. Step 75 displays the screen output to the recipient's screen by means of the remote access modules 28 and 33. If the recipient is permitted to open an attachment, that process will launch the corresponding XUAP application. Alternatively, launching the e-mail application might also immediately launch any XUAP application program necessary to process any attachment to the e-mail message.

Another rule output may designate whether a message, such as an attachment to an e-mail message, can be manipulated. Using the foregoing example, if the message were not manipulable, the rule output would only allow the recipient to view the attachment remotely from the sacrificial machine 14. If it were manipulable, the recipient might be alter the attachment using the corresponding XUAP application.

Step 76 in FIG. 4 tests the rule output to determine whether the message is manipulable. If it is not, step 77 terminates the process by destroying the virtual environment in the sacrificial machine. This completes the procedure 72.

If, however, the selected forwarding rule allows manipulation, all processing occurs in the sacrificial machine 14. Consequently, if the “blocked” message produces adverse effects, only the sacrificial machine 14 is affected. Neither the recipient's computer system nor the server will be affected.

Manipulation can include any number of processes. For example, in one embodiment the recipient issues inputs that constitute commands. When the recipient is done with the manipulation, the recipient computer system issues an “Exit” command. Control passes from step 78 to step 77 terminating the manipulation process.

If the input constitutes a “Safe Derivative” command, step 80 transfers control to step 81. Step 81 implements a process by which the message or attachment being displayed is converted into a safe or clean form, called a “derivative”. For example, if the attachment being displayed is a spreadsheet, step 81 might initiate a process for converting the spreadsheet file to a derivative PDF document thereby stripping any macros associated with the spreadsheet file. After the conversion is complete, step 82 transfers the derivative document, such as the PDF document, to the recipient computer system. As it is safe, the receipt of the PDF document poses no risk of corrupting the recipient computer system.

For all other inputs, steps 78 and 80 pass control to step 83 that processes any command constituted by the inputs. This loop comprising steps 76, 78 and 80 through 83 continues until the Exit command is received causing step 78 to transfer control to step 77 that destroys the virtual environment in the sacrificial machine 14. A new virtual environment may then be created.

When the processing in FIG. 4 ends, control transfers back to step 84 in FIG. 3 that terminates the remote access session and the processing of the selected message. Then control transfers back to step 60 to initiate the process with another blocked message.

In some situations an appropriate processing of a blocked message may be to download it to a user. As an example, assume a spreadsheet attachment passes the virus detection test but fails the validity test because the spreadsheet has a macro and the validity rules will not pass any spreadsheet with a macro. A forwarding rule output may decide that such a “blocked” message can be delivered or downloaded to the user if the source is a trusted source. In that or other similar situations, control passes from step 63 in FIG. 3 to step 85. Step 86 then downloads the message to the recipient as it would if the message had been deemed to be valid by the server testing module 20 in FIGS. 1 and 2. Control transfers back to step 60 to process any other message in the blocked message store 24.

Step 87 represents other processes that a forwarding rule output may define. For example, a rule output might specify a destruction date. Step 87 could then add this parameter to the blocked message data in the blocked message store 24.

### Server ADMIN Module 90

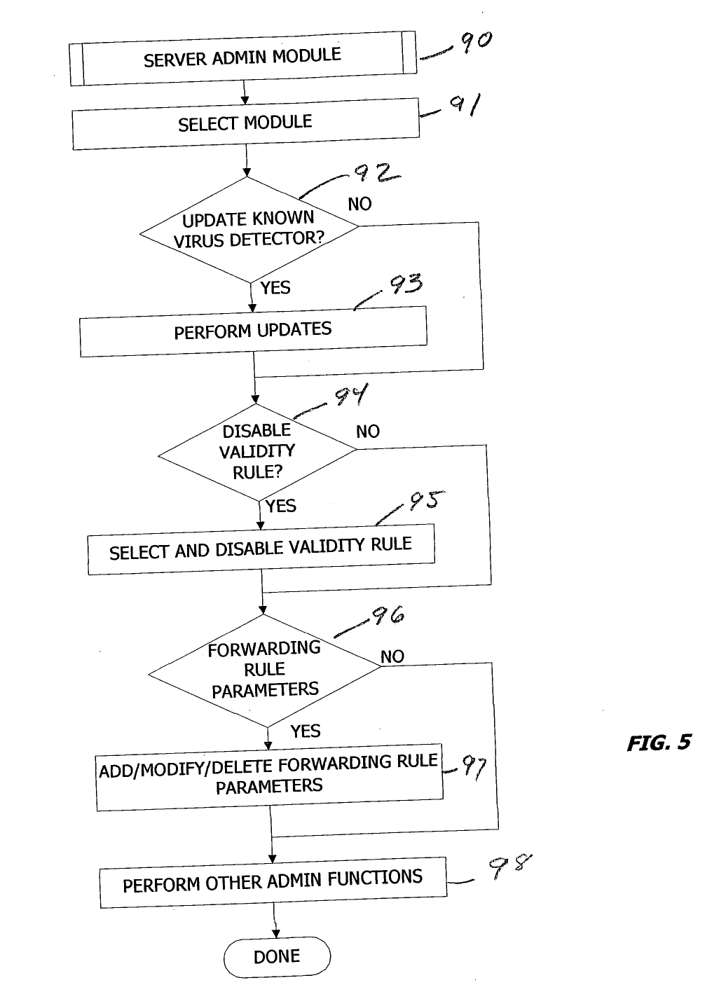

As with most application programs in use today, this program will have different operating modes, such as an “administrator” or “ADMIN” mode and “USER” modes. Additional functions assigned to an administrator by this invention are shown in FIG. 5 as a server ADMIN module 90. Basically this module 90 enables the administrator to monitor and control operations in the other modules associated with this invention. Typically the module 90 will reside in the server 10.

Step 91 in FIG. 5 represents the selection of this module 90 for use. The administrator uses steps 92 and 93 to update the known virus detector 21, with step 93 being used to provide updates to virus definitions or other updating tasks or to set the switch used by step 43 in FIG. 2.

Generally speaking, it is expected that the validity rules will be fixed. However, in some situations the administrator may be given the authority to disable one or more rules. Steps 94 and 95 provide the administrator with the necessary tools for performing that function.

Steps 96 and 97 permit the administrator to add or delete rules or to change various forwarding rule parameters. For example, the administrator could use step 97 to set the rule output regarding notification of a recipient in the case of a message to be deleted as used by step 66 in FIG. 3. Step 97 could also be used to alter the contents of any database information about network users that would be included in the forwarding rules, such as to change a user from one user class to another.

Still other administrative functions could be included in this module of FIG. 5. For example, a rule might be used in this situation to set a destruction date for the blocked message in the blocked message store 24. Step 98 represents such a function or any and all other functions that may, from time to time, be used to alter the forwarding rule parameter store 25.

Now looking at this invention from the perspective of a recipient, one of two possible events will occur upon receipt of a message in the server 10. If the message is determined to be valid the server testing module 20, the recipient sees the message at the recipient's computer system. The operation of the invention will be transparent to the recipient. The recipient can interact with the message in any manner normally provided by the application programs.

The second possible event occurs if the message is blocked. Then the forwarding rules control the notice to the recipient. That notice will also indicate whether the message is available for viewing and possible interaction or manipulation on a restricted basis or not available. In some situations the message may be transferred to the recipient's computer system.

In accordance with the objectives of this invention, the structure and methodology described above allows messages that are known to be valid to pass to a recipient computer system. By retaining all other messages in the blocked message store 24, any corrupting message does not automatically transfer beyond the server handling the incoming messages. This provides a first degree of immunization to all the other computer systems in the network. All “blocked” messages are then handled remotely to the recipient's computer system and the server.

Handling messages in the blocked message store 24 by means of a set of forwarding rules adds another level of immunization. These rules may call for the immediate deletion of the message from the blocked message store 24, again without any transfer out of the server. If the rules permit access, that access occurs through a remote access protocol with a copy of the message in the sacrificial machine 14. Interacting with the “blocked” message in a sacrificial machine 14 assures that neither the server nor any user computer system will be corrupted. It also allows the formation of a derivative of a blocked message, such as a blocked e-mail message or attachment, for transfer to the recipient's computer system assuming the forwarding rules permit such an action. In this manner useful data in an infected file can be delivered to the recipient without risk of any adverse effects caused by a virus.

As a result, using some or all of the features of this invention immunizes each computer system and the server in a network against adverse effects of received corrupting messages. More specifically, allowing only messages known to be valid to transfer to a recipient computer system while blocking all other messages immunizes the recipient's computer system from any adverse effects of a corrupting message. As will also be apparent, the disclosed apparatus and methodology will immunize a computer system against the prior art adverse effects of false negative messages and false positive messages.

Now it will be apparent that this invention has been disclosed in terms of certain embodiments, but that many modifications can be made to the disclosed apparatus and methodology without departing from the invention. FIGS. 1 through 5 depict a specific logical representation of this invention from which diverse implementations will be apparent to those skilled in the art. For example, the modules in FIGS. 2 through 5 depict specific functional sequences of procedures or steps. These specific sequences can be altered. With specific reference to FIG. 3, the blocked message handler module is described as a number of steps performed in a sequential nature. In another implementation one could provide a functional equivalent through a hardware decision tree logic circuit or a coded module that monitors a number of inputs to generate a signal or signal sequence as a rule output. Therefore, it is the intent of the appended claims to cover all such variations and modifications as come within the true spirit and scope of this invention.

What is claimed as new and desired to be secured by Letters Patent of the United States is:

1. A method for immunizing computer systems in a computer network from the adverse effects of a corrupting message received over a communications path for a recipient computer system on the computer network, wherein the computer network includes a server with a blocked message store and said method comprises the steps of:
A) receiving the message in the server,
B) determining whether the message meets criteria for a valid message,
C) transferring the message to the recipient computer system if the message meets the criteria, and
D) transferring the message to the blocked message store if the message fails to meet the criteria.

2. A method as recited in claim 1 wherein said determination that a message meets the criteria for a valid message includes:
i) determining whether the message has criteria establishing that the message is deemed to be valid, and
ii) determining whether the message has criteria establishing that the message is deemed to be invalid.

3. A method as recited in claim 2 wherein one of said determinations is that the message is deemed to be invalid and said method includes processing the message according to one of a plurality of actions including designating the message for deletion from the blocked message store, deleting the message from the blocked message store, transferring the message to the recipient computer system and making the message accessible to the recipient on a restricted basis.

4. A method as recited in claim 2 wherein said transferring of the message to the blocked message store includes generating characteristics of the message and said method includes handling the message in response to a set of forwarding rules and those characteristics of the message.

5. A method as recited in claim 4 wherein one of said determinations for a message in the blocked message store is that the message is not deemed to be invalid and not deemed to be valid and said handling includes processing the message in accordance with a forwarding rule that causes the message to be designated for deletion from the blocked message store, that deletes the message from the blocked message store, that transfers the message to the recipient computer system or that makes the message accessible to the recipient computer system on a restricted basis.

6. A method as recited in claim 4 wherein the computer network includes a remote access connection for establishing communications between a sacrificial machine with computing capabilities and the recipient computer system, said method enabling the recipient computer system to communicate with the sacrificial machine by:
i) copying the message to the sacrificial machine to establish a virtual environment,
ii) enabling the recipient to view the copy of the message in the sacrificial machine remotely, and
iii) destroying the virtual environment, including the copy of the message, in the sacrificial machine upon completion of the viewing.

7. A method for immunizing computer systems in a network from the adverse effects of a corrupting message received over a communications path for a recipient computer system wherein the computer network includes a server with a blocked message store and said method comprises the steps of:
A) establishing a set of criteria by which each received message can be classified as a blocked message,
B) establishing a set of forwarding rules that control the processing of each blocked message,
C) transferring a received message classified as a blocked message to the blocked message store, and
D) processing each blocked message transferred to the blocked message store in accordance with a forwarding rule.

8. A method as recited in claim 7 wherein said transfer of a blocked message to the blocked message store additionally transfers characteristics of the blocked message and said processing selects a forwarding rule based upon those message characteristics.

9. A method as recited in claim 8 wherein the selected forwarding rule causes the designation of a message for deletion from the blocked message store, deletes the message from the blocked message store, transfers the message to the recipient computer system or makes the message accessible to the recipient computer system on a restricted basis.

10. A method as recited in claim 8 wherein the computer network includes a sacrificial machine with computing capabilities, said message processing including the selection of a forwarding rule by which said blocked message processing:
i) copies the blocked message to the sacrificial machine to establish a virtual environment therein,
ii) enables remote processing of the copy of the message in the sacrificial machine from the recipient computer system in response to the selected forwarding rule, and
iii) destroys the virtual environment, including the copy of the message, in the sacrificial machine upon completion of said processing.

11. A method as recited in claim 10 wherein the selected forwarding rule causes said remote processing to display the copy of the message at the recipient computer system.

12. A method as recited in claim 11 wherein the sacrificial machine includes means for processing the copy of the message independently of the recipient computer system and wherein remote access to the sacrificial machine is enabled from the recipient computer system in response to the forwarding rule whereby said remote processing of the message by the application responds to input from the recipient computer system.

13. A method as recited in claim 11 wherein the sacrificial machine includes means for processing the copy of the message independently of the recipient computer system and wherein remote access to the sacrificial machine is enabled from the recipient computer system in response to the forwarding rule whereby said remote processing of the message:
i) generates a derivative message that is based upon the copy of the message and that is free of corruption, and
ii) transfers the derivative message to the recipient computer system.

14. A method for immunizing a computer network from the adverse effects of a corrupting message received over a communications path wherein the computer network includes a server with a blocked message store and said messages from said communications path identify a recipient computer system in the computer network, said method comprising the steps of:
A) receiving each message over the communications path in the server,
B) processing the message to determine message characteristics including the steps of:
i) transferring the message to the recipient computer system if the message is deemed to be free of any potentially corrupting criteria, and
ii) transferring the message characteristics and message to the blocked message store if the message is not deemed to be free of any potentially corrupting criteria, and
C) handling each message in the blocked message store including the steps of:
i) selecting a message from the blocked message store,
ii) obtaining characteristics of the message, and
iii) processing the message characteristics to select one of a set of forwarding rules that control the handling of the message in the blocked message store.

15. A method as recited in claim 14 wherein the transfer to the recipient computer system occurs if the message matches a criterion for messages that are deemed to be valid.

16. A method as recited in claim 14 wherein the transfer to the blocked message store occurs if the message fails to match any criteria of a message that is deemed to be valid and matches criteria for a message that is deemed to be invalid.

17. A method as recited in claim 14 wherein the characteristics for the selected message produce the selection of a rule for causing said processing of one or more of a plurality of actions including designation of the message for deletion from the blocked message store, deletion of the message from the blocked message store, transfer of the message to the recipient computer system or the enablement of access of the recipient computer system to the message on a restricted basis.

18. A method as recited in claim 17 wherein said access enablement includes:
i) copying the message to a sacrificial machine with computing capabilities to establish a virtual environment,
ii) enabling the recipient to process the copy of the message in the sacrificial machine remotely, and
iii) destroying the virtual environment, including the copy of the message, in the sacrificial machine upon completion of the viewing.

19. A method as recited in claim 18 wherein said message processing includes the display of the copy of the message at the recipient computer system.

20. A method as recited in claim 18 wherein said message processing includes:
i) generating a derivative message that is based upon the copy of the message and that is free of corruption, and
ii) transferring the derivative message to the recipient computer system.

21. Apparatus for immunizing computer systems in a network from the adverse effects of a corrupting message received over a communications path for a recipient computer system on the computer network wherein the computer network includes a server with a blocked message store, said apparatus comprising:
A) means for receiving the message in the server,
B) means for determining whether the message meets criteria for a valid message,
C) means for transferring the message to the recipient computer system if the message meets the criteria, and
D) means for transferring the message to the blocked message store if the message fails to meet the criteria.

22. Apparatus as recited in claim 21 wherein said valid message determination means includes:
i) means for determining whether the message has criteria establishing that the message is deemed to be valid, and
ii) means for determining whether the message has criteria establishing that the message is deemed to be invalid.

23. Apparatus as recited in claim 22 wherein one of said determination of a valid message is that the message is deemed to be invalid and said apparatus includes means for processing the message that includes at least one of:
i) means for designating the message for deletion from the blocked message store,
ii) means for deleting the message from the blocked message store,
iii) means for transferring the message to the recipient computer system, and
iv) means for making the message accessible to the recipient on a restricted basis.

24. Apparatus as recited in claim 22 wherein said means for transferring the message to the blocked message store includes means for generating characteristics of the message and said apparatus includes:
i) a plurality of forwarding rules, and
ii) means for handling the message in response to a forwarding rule selected in response to those characteristics of the message.

25. Apparatus as recited in claim 24 wherein one of said determinations for a message in the blocked message store is that the message is not deemed to be invalid and not deemed to be valid and wherein said handling means processes the message in accordance with a selected one of the following forwarding rules:
i) a forwarding rule that causes the message to be designated for deletion from the blocked message store,
ii) a forwarding rule that deletes the message from the blocked message store,
iii) a forwarding rule that transfers the message to the recipient computer system, or
iv) a forwarding rule that makes accessible to the recipient computer system on a restricted basis.

26. Apparatus as recited in claim 24 including a sacrificial machine with computing capabilities and means for establishing remote access between said sacrificial machine and the recipient computer system to enable recipient computer system to communicate with the sacrificial machine, said sacrificial machine including:
i) means for copying the message to the sacrificial machine to establish a virtual environment,
ii) means for enabling the recipient to view the copy of the message in said sacrificial machine by said remote access means, and
iii) means for destroying the virtual environment, including the copy of the message, in said sacrificial machine upon completion of the viewing.

27. Apparatus for immunizing computer systems in a network from the adverse effects of a corrupting message received over a communications path for a recipient computer system wherein the computer network includes a server with a blocked message store, said apparatus comprising:
A) means for establishing a set of criteria by which each received message can be classified as a blocked message,
B) means for establishing a set of forwarding rules that control the processing of each blocked message,
C) means for transferring a received message classified as a blocked message to said blocked message store, and
D) means for processing each blocked message transferred to said blocked message store in accordance with a forwarding rule.

28. Apparatus as recited in claim 27 wherein said means for transferring a blocked message to the blocked message store includes means for generating characteristics of the blocked message and said processing means includes means for selecting a forwarding rule based upon those message characteristics.

29. Apparatus as recited in claim 28 wherein said set of forwarding rules includes at least one forwarding rule that causes the designation of a message for deletion from the blocked message store, that deletes the message from the blocked message store, that transfers the message to the recipient computer system or that makes the message accessible to the recipient computer system on a restricted basis.

30. Apparatus as recited in claim 28 wherein the computer network includes a sacrificial machine with computing capabilities and said message processing means includes:
i) means for copying the blocked message to said sacrificial machine to establish a virtual environment therein,
ii) means for enabling remote processing of the copy of the message in said sacrificial machine from the recipient computer system in response to the selected forwarding rule, and
iii) means for destroying the virtual environment, including the copy of the message, in said sacrificial machine upon completion of processing.

31. Apparatus as recited in claim 30 wherein said remote processing means includes means for displaying the copy of the message at the recipient computer system.

32. Apparatus as recited in claim 31 wherein said sacrificial machine includes means for processing the copy of the message independently of the recipient computer system and wherein said remote processing means includes means for responding to input from the recipient computer system.

33. Apparatus as recited in claim 31 wherein said sacrificial machine includes means for processing the copy of the message independently of the recipient computer system and wherein said remote access means enables remote access by the recipient computer system in response to the forwarding rule and wherein said remote processing means includes:
i) means for generating a derivative message that is based upon the copy of the message and that is free of corruption, and
ii) means for transferring the derivative message to the recipient computer system.

34. Apparatus for immunizing a computer network from the adverse effects of a corrupting message received over a communications path wherein the computer network includes a server with a blocked message store and said messages from said communications path identify a recipient computer system in the computer network, said method comprising the steps of:
A) means for receiving each message over the communications path in the server,
B) means for processing the message to determine message characteristics including the steps of:
i) means for transferring the message to the recipient computer system if the message is deemed to be free of any potentially corrupting criteria, and
ii) means for transferring the message characteristics and message to the blocked message store if the message is not deemed to be free of any potentially corrupting criteria,
C) means for storing a set of forwarding rules that control message processing,
D) means for handling each message in the blocked message store including:
i) means for selecting a message from the blocked message store,
ii) means for obtaining characteristics of the message, and
iii) means for processing the message characteristics to select one of forwarding rules in said storing means that control the handling of the message in the blocked message store.

35. Apparatus as recited in claim 34 including means for transferring a message to the recipient computer system if the message matches a criterion for messages that are deemed to be valid.

36. Apparatus as recited in claim 34 including means for transferring a message to the blocked message store if the message fails to match any criteria of a message that is deemed to be valid and matches criteria for a message that is deemed to be invalid.

37. Apparatus as recited in claim 34 wherein said set of forwarding rules includes a one or more rules for designating a message for deletion from said blocked message store, for deleting a message from the blocked message store, for transferring a message to the recipient computer system or for enabling access of the recipient computer system to the message on a restricted basis.

38. Apparatus as recited in claim 37 additionally includes a sacrificial machine for processing messages and said message handling means includes:
i) means responsive to the selection of the enabling rule for copying the message to said sacrificial machine to establish a virtual environment,
ii) means for enabling the recipient to process the copy of the message in said sacrificial machine remotely, and
iii) means for destroying the virtual environment, including the copy of the message, in said sacrificial machine upon completion of the viewing.

39. Apparatus as recited in claim 38 including means for displaying the copy of the message in said sacrificial machine at the recipient computer system.

40. Apparatus as recited in claim 38 wherein said sacrificial machine includes:
i) means for generating a derivative message that is based upon the copy of the message and that is free of corruption, and
ii) means for transferring the derivative message to the recipient computer system.
